(19) United States
(12) Patent Application Publication
(10) Pub. No.: US 2005/0191009 A1
(43) Pub. Date: Sep. 1, 2005

(54) Hookup connection between a fiber-optics hookup cable and an endoscope optics

(75) Inventors: Mathias Kraas, Haseldorf (DE); Uwe Schrader, Hamburg (DE); Frank-Michael Smid, Hamburg (DE)

Correspondence Address: RANKIN, HILL, PORTER & CLARK LLP, 4080 ERIE STREET, WILLOUGHBY, OH, 44094-7836, US

(73) Assignee: Olympus WINTER & IBE GMBH, Hamburg (DE)

(21) Appl. No.: 11/056,574

(22) Filed: Feb. 11, 2005

(30) Foreign Application Priority Data
Feb. 26, 2004 (DE) 10 2004 009 218.4

(51) Int. Cl. G02B 6/36

(52) U.S. Cl. 385/53; 385/117

(57) ABSTRACT

A hookup connection between a fiber optics hookup cable (7) and an endoscope optics (1). A connector (6) of the hookup cable (7) including a snap-in device (16) for snap-in engagement into at least one recess (17) running on the circumference of a hookup terminal (5) of the endoscope optics (1). The connector (6) includes a guide sleeve (13) and a locking element (16). The guide sleeve (13) receives and guides the hookup terminal (5) and constitutes, at an end near the cable, a cable socket (12). The locking element (16), which engages the recess, is radially displaceable in a supported manner and is configured in the region of the recess. A handling bush (18) is supported in a longitudinally displaceable manner on the guide sleeve (13) and is axially braced in both directions against the guide sleeve (13) by springs (20, 21). The handling bush (18) is fitted at the site of the recess (17) with an inwardly projecting boss (19) which, in the rest position of the handling bush (18), maintains the locking element (16) in its locked position.

### BACKGROUND OF THE INVENTION

Hookup connections are used to detachably affix to endoscope optics, a fiber-optics hookup cable, connected at its other end to a light source. In the conventional state of the art,, both the endoscope optics and the hookup cable are traversed by a fiber optic bundle, the two bundle ends being held mutually flush at the connection site.

Hookup connections linking endoscopes to light guides are already known, whereby the cable's terminals are affixed on the endoscope terminal and then are secured in place by a screw cap. This screwing procedure is a drawback in that it may be exceedingly laborious when using bloodstained gloves. Also, if the screwing is carried out improperly, the hookup cable may drop off during surgery. The consequences may then be catastrophic.

When being merely plugged together, hookup connections of the above species will snap into position, securing the connection in this manner. Screw connections are eliminated. In known connections of this type, however, only snap-in implementation is provided against a spring force which will automatically be overcome if the opposite tension is sufficient. Again, the drawback is that during surgery the connection may be undone and the illumination of the field of surgery shall be interrupted, causing jeopardy to the patient.

The objective of the present invention is to create a hookup connection of the above kind which is easy to handle but nevertheless stays reliably connected.

### BRIEF SUMMARY OF THE INVENTION

In the present invention, a handling bush axially displaceable on a guide sleeve is engaged when the connector is engaged. By means of springs, the handling bush is in a rest position in both axial directions, an inside boss keeping the locking element in the engaged position. If no axial force acts on the handling bush, the snap-in status is reliably maintained so that even in the event of substantial retracting forces, accidental disengagement of the hookup cable is precluded. Deliberate disengagement of the hookup cable is carried out by grasping the handling element and pulling it away from the endoscope optics. As a result, the handling bush shifts axially, and the boss being moved jointly with the handling bush will release the locking element, resulting in disengagement of the connector. During engagement, the handling bush is forced toward the endoscope optics, resulting in a departure of the boss from the locking element and the snap-in engagement can then be completed. Consequently, the present invention creates a hookup connection which is handled in very simple ergonomic manner, namely by forcing the handling bush into an engaging or disengaging direction. When no force acts on the handling bush, the connector shall be in a highly reliable locked mode.

The locking element may be configured in an arbitrary, axially displaceable manner in an axial borehole of the guide sleeve, for instance in the form of a ball resting in it. Advantageously, by resting the locking element on a tab running in the axial direction and cut out in a U-shaped manner from the guide sleeve, a very simple design including a loss-proof locking element is provided.

The axially resilient springs may be arbitrary, for instance being leaf springs or in the form of voluminary elastic bodies that brace the handling bush relative to the guide sleeve. The elastic bodies optionally are designed to assure an accurate location in the rest position.

The recess on the endoscope optic's hookup terminal is a circumferential groove. The connector's locking element may enter this groove at any angular position and the hookup cable may be rotated relative to the endoscope optics while being securely held. The hookup terminal and the circumferential groove may be designed in a manner such that they also allow hooking up conventional hookup connections that also require a groove on the hookup terminal.

By axially beveling the locking element forward and rearward, it is possible, in a conventional manner, for the locking element to easily enter the recess and that upon retraction it shall be easily retracted.

The present invention is shown in illustrative and schematic manner in the appended drawings.

### BRIEF DESCRIPTION OF THE SEVERAL VIEWS OF THE DRAWINGS

FIG. 1 is a sideview of a connector linking a hookup cable and an endoscope optics,

FIG. 2 is an enlarged section of the connector of FIG. 1,

FIG. 3 is an elevation according to FIG. 2 of part of the connector, and

FIG. 4 is a section along line 4-4 of FIG. 3.

### DETAILED DESCRIPTION OF THE INVENTION

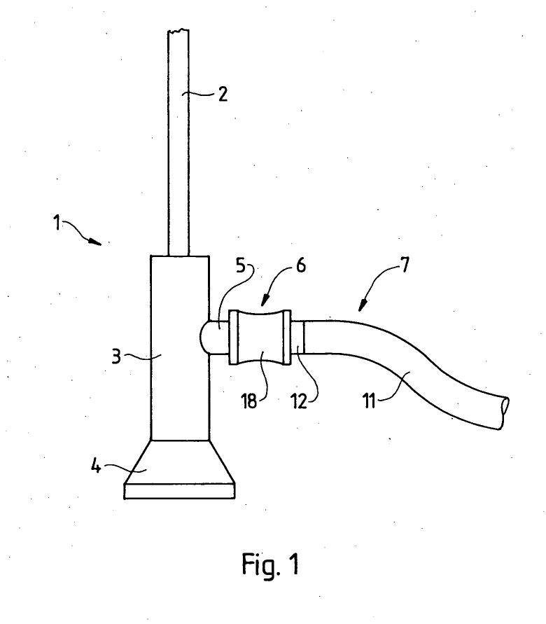

FIG. 1 shows known endoscope optics 1 comprising a stem 2, a main case 3, an ocular 4 and a hookup terminal 5 onto which is slipped a fiber optics hookup cable 7 using a connector 6.

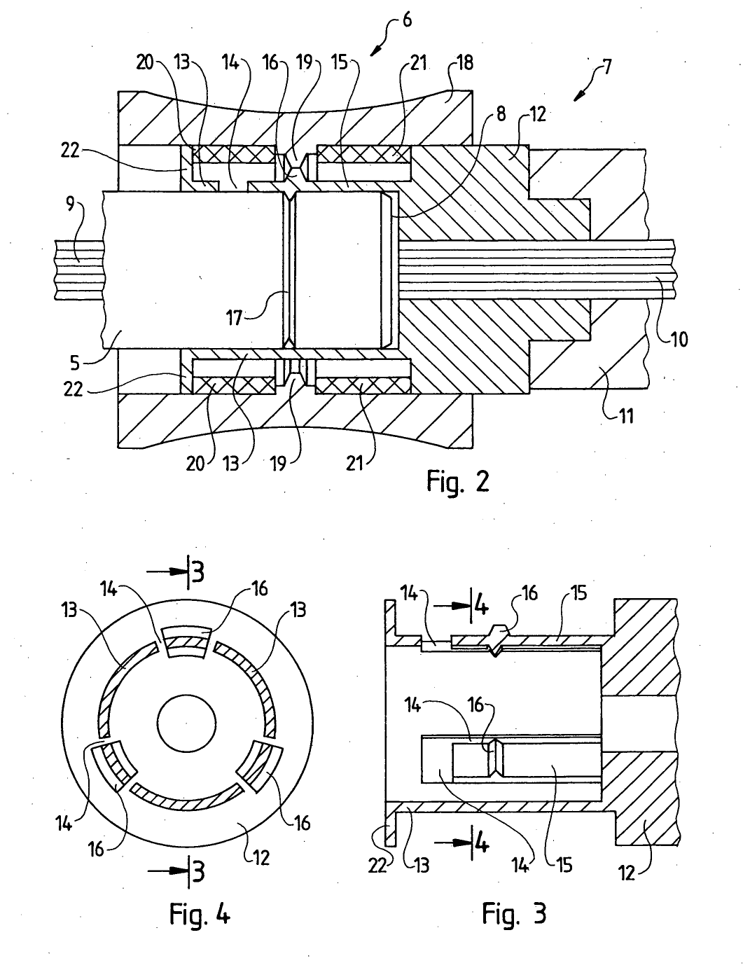

Particulars of the connector 6 of the present invention are shown in the enlarged section of FIG. 2. FIG. 2 shows the hookup terminal 5 which is traversed by an optic fiber bundle 9 as far as its end face 8. The fiber optics hookup cable 7 also is traversed by an optic fiber bundle 10. The optic fiber bundle 10 in the fiber optics hookup cable 7 is enclosed lengthwise by a sheath 11 and is held at the end near the endoscope in a cable socket 12 which at its end merges into a guide sleeve 13 of which the inside dimensions assure a close fit receiving the hookup terminal 5.

FIGS. 3 and 4 show the guide sleeve 13 as a single part. U-shaped slots 14 ending in the cable socket 12 are present in the guide sleeve 13, at least one of these slots (FIG. 4), in the embodiment three slots, circumferentially clearing resilient tabs 15 which are affixed by their ends to the cable socket 12.

Each of the three resilient tabs 15 is fitted with a locking element 16 projecting from the resilient tab 15 both inward and outward, these projections each being beveled axially forward and rearward as especially clearly shown in FIG. 2.

In the snap-in position, the portions of the locking elements 16 projecting inward over the resilient tab engage a circumferential groove 17 of the hookup terminal 5.

A handling bush 18 rests in an axially displaceable manner on the outside of the guide sleeve 13, i.e. on the cable socket 12, and is fitted on its inside surface with an inwardly projecting boss 19 which in this illustrative embodiment mode runs circumferentially around the handling bush 18.

In the rest position shown in FIG. 2, the boss 19 externally abuts the locking element 16 which it retains in the engagement position of the groove 17 of the hookup terminal 5.

The handling bush 18 is axially displaceable both forward and backward relative to the guide sleeve 13 and is resiliently braced relative to the sleeve by a front spring 20 and a rear spring 21. In this embodiment the springs 20 and 21 are made of a voluminally elastic material, namely in the form of rings running around the inside surface of the handling bush 18, illustratively being simple rubber hoops.

Each of the two springs 20 and 21 rests by one end against the boss 19 and axially by the other end against the guide sleeve 13. For that purpose, the sleeve is fitted at its end away from the cable socket 12 with an external flange 22 supporting the spring 20 and, moreover, acting as a guide for the handling bush 18. By its other end, the spring 21 rests against an end face of the cable socket 12.

In the position of the connector 6 shown in FIG. 4, the locking elements 16 engage the groove 17 and are kept engaged by the boss 19. In this manner, the connector is secured against accidental disengagement. To disengage the connector, the handling bush 18 is grasped by the fingers of one hand and is pulled in the OFF position, that is in the direction of the fiber optics hookup cable 7. In the process, the rear spring 21 will be compressed and the handling bush 18 shall move relative to the guide sleeve 13 until the boss 19 moves off the locking element 16. The locking element 16 now is able to elastically move out of the way, allowing the cable to be pulled out.

To move into the engaged position again, the handling bush 18 is grasped and forced against the endoscope optics 1. In this process, the front spring 20 is compressed and as a result the handling bush 18 is shifted relative to the guide sleeve 13 and the boss 19 releases the locking elements 16. When the guide sleeve 13 is slipped onto the hookup terminal 5, the locking elements may elastically move outward and enter the groove 17. Once the handling bush 18 is released, it will be moved by the force of the two springs 20 and 21 into the central position, shown in FIG. 2, to lock the snap-in condition by means of the engagement between the boss 19 and the locking elements 16.

1. A hookup connection between a fiber optics hookup cable (7) and an endoscope optics (1), where a connector (6) of the hookup cable (7) comprises a snap-in device (16) to snap into at least one recess (17) on a circumference of a hookup terminal (5) of the endoscope optics (1) and where the connector (6) is fitted with a guide sleeve (13), said guide sleeve receiving and guiding the hookup terminal (5) and constituting a cable socket (12) at an end of the guide sleeve near the cable, a locking element (16) being supported in radially displaceable manner in a region of the recess (17) in order to engage said recess, wherein
a handling bush (18) is supported in a longitudinally displaceable manner on the guide sleeve (13) and is axially braced by springs (20, 21) in both directions relative to the guide sleeve (13), the handling bush (18) being fitted with an inwardly projecting boss (19) at said recess (17), said boss keeping the locking element (16) in the locked position when the handling bush (18) is in a rest position.

2. The hookup connection as claimed in claim 1, wherein the locking element (16) rests on a tab (15) running in an axial direction and cut out in a U-shaped manner from the guide sleeve (13).

3. The hookup connection as claimed in claim 1, wherein the springs are formed as voluminally elastic bodies (20, 21).

4. The hookup connection as claimed in claim 1, wherein the recess is a circumferential groove (17).

5. The hookup connection as claimed in claim 1, wherein, in its engagement zone into the recess (17), the locking element (16) is axially beveled forward and rearward.
